(19) United States
(12) Patent Application Publication
(10) Pub. No.: US 2010/0015369 A1
(43) Pub. Date: Jan. 21, 2010

(54) Method for producing a container from aluminum sheets

(75) Inventors: Dietmar Schröder, Grevenbroich (DE); Stefan Wöste, Koln (DE)

Correspondence Address: PROSKAUER ROSE LLP, ONE INTERNATIONAL PLACE, BOSTON, MA, 02110, US

(73) Assignee: HYDRO ALUMINIUM DEUTSCHLAND GMBH, KOLN (DE)

(21) Appl. No.: 12/303,306

(22) PCT Filed: Jun. 1, 2007
(86) PCT No.: PCT/EP07/55419

§ 371 Date: May 15, 2009

(30) Foreign Application Priority Data
Jun. 7, 2006 (DE) 10 2006 026828.8

(51) Int. Cl. B32B 1/02; C21D 7/06

(52) U.S. Cl. 428/34.1; 72/53

(57) ABSTRACT

A method for producing a container from sheets of aluminum or an aluminum alloy, wherein the surfaces of the aluminum sheets are at least partly visible on the finished container includes partly prefabricating the container by working and/or joining the aluminum sheets, and subsequently subjecting the entire, at least prefabricated container to surface processing by mechanical blasting.

### CROSS-REFERENCE TO RELATED APPLICATIONS

This application is a National Phase Application of International Application No. PCT/EP2007/055419, filed on Jun. 1, 2007, which claims the benefit of and priority to German patent application no. DE 10 2006 026 828.8-14, filed Jun. 7, 2006. The disclosure of the above applications are incorporated herein by reference in their entirety.

### FIELD OF THE INVENTION

The invention relates to a method for producing a container (such as, for example, fuel tanks) from sheets of aluminum or an aluminum alloy, wherein the surfaces of the aluminum sheets are at least partly visible on the finished container. Furthermore the invention relates to a corresponding container at least partly consisting of sheets of aluminum or an aluminum alloy.

### BACKGROUND

Containers in the sense of the present invention in particular are understood to mean technical containers for transporting liquid, gaseous or solid materials, for example pressure vessels, fuel tanks or transport containers for liquid or free-flowing goods. Usually these containers are made from a plurality of joined or individual, formed aluminum sheets. Containers made from aluminum sheets are increasingly replacing containers, which are made of steel sheets due to the weight savings. Apart from the technical, for example mechanical properties of the containers made from aluminum sheets in addition the decorative characteristics of the container also stand in the foreground. For example fuel tanks for heavy goods vehicles frequently consist of a plurality of joined sections, which are made up of individual aluminum sheets. Due to varying manufacturing parameters or storage times of the aluminum sheets used, these frequently have a different surface appearance. In order to avoid a blotty appearance of the fuel tank immediately after assembly, the fuel tanks are therefore surface coated and/or painted in order to obtain a homogeneous surface. A problem with surface coating the container now is that this is expensive and leads to additional costs in the production of the container. Furthermore the surface-coated containers do not show the typical decorative metallic brightness of an uncoated aluminum surface. In order nevertheless to provide containers with uncoated aluminum surfaces and a uniform appearance, up to now before the different aluminum sheets are joined, they undergo exact examination with respect to their surface appearance and only aluminum sheets which are alike or those with similar characteristics are used for production. The rejection thus arising and the additional technical expense of selecting and holding aluminum sheets with different surface appearances in readiness however bear no relationship to the effect obtained of a decorative, uniform surface of the entire container. On the other hand there is additionally a risk that surface damage will also result from handling the container during assembly, leading to rejection or rework.

### SUMMARY OF THE INVENTION

An aspect of the present invention is to make available a method for producing a container from aluminum sheets by which containers with decorative, visible aluminum surfaces can be produced at low cost.

Furthermore another aspect of the invention is to provide containers produced in accordance with the above method.

In a first teaching of the present invention the aspect indicated above for a generic method is achieved in that the container is at least partly prefabricated by working and/or joining the aluminum sheets, which are visible on the finished container, and subsequently the entire, at least prefabricated container is subjected to surface working by mechanical blasting.

Surprisingly it has been shown that the different appearance of the aluminum sheets used can be changed by mechanical blasting of the already partly assembled container, such that the containers have aluminum surfaces with a uniform, decorative appearance and metallic brightness. In addition also superficial defects, arising during assembly for example by working or joining, which up till now have led to rejection in production, are eliminated to a certain degree by mechanical blasting, so that with the method according to the invention the reject and rework rate can be substantially reduced during assembly of the containers. The containers produced in this way can be very satisfactorily used uncoated. Further coating of the aluminum surfaces can be omitted so that the method according to the invention is particularly economic. In addition the aluminum surfaces of the containers are hardened by mechanical blasting, as a result of which the containers become more resistant to mechanical surface damage.

According to a first embodiment of the method according to the invention, the container is finally assembled by working and/or joining the aluminum sheets and the entire, finally assembled container is mechanically blasted, so that the surface processing of the container takes place in the last manufacturing step. As a result of the advantageous method therefore superficially defect-free containers, which have a particularly decorative surface, can be provided especially easily. Preferably at least the mechanically blasted aluminum surfaces are not subjected to further coating and therefore remain uncoated.

According to another embodiment of the method according to the invention mechanical blasting is carried out using glass beads, corundum, white corundum, sand and/or steel balls. Glass beads, corundum, white corundum and sand, compared to steel balls, have the advantage that they do not lead to additional ingress of iron in the blasted aluminum surfaces, which is to be avoided for reasons of corrosion. On the other hand a high degree of hardness of the aluminum surface can be achieved with steel balls, so that the resistance of the aluminum surfaces can be greatly increased with respect to mechanical influences, for example stone-chips. The use of other media or blends thereof is also conceivable for mechanical blasting.

Preferably the container is a pressure vessel, a fuel tank, in particular a modularly-constructed fuel tank or a transport container for liquid or free-flowing goods. All the containers mentioned are frequently assembled by the modular construction method or produced from a number of aluminum sheets and preferably used uncoated, so that these containers can be manufactured particularly economically with the method according to the invention.

According to another embodiment of the method according to the invention the aluminum sheets consist of an aluminum alloy of the type 3xxx, 5xxx and/or 6xxx. Aluminum alloys of the type 3xxx are distinguished by good formability so that joining and working of the aluminum sheets to produce container in a simple manner. On the other hand the mechanical properties of the aluminum alloys of the type are 3xxx not as good as those of the aluminum alloys of the type 5xxx and 6xxx. Aluminum alloys of the type 6xxx have the best mechanical properties of the alloy types mentioned. However the formability of the aluminum alloy 6xxx in turn is not as good as that of the type 5xxx. A satisfactory compromise between very good mechanical properties, good formability and good corrosion resistance is represented by the aluminum alloy of the type 5xxx. It is common to all three alloy types mentioned that with mechanical blasting these tend to a high degree of surface hardness, which substantially improves the resistance of the aluminum surface with respect to mechanical damage.

According to a second teaching of the present invention the aspect deduced above is achieved by a generic container in that, after assembly of at least the visible aluminum sheets by joining and/or working, the visible aluminum surfaces are surface-processed by mechanical blasting of the entire, at least prefabricated container.

As already stated above mechanical blasting of the aluminum surfaces after assembly of the container leads to a homogeneous appearance of the aluminum surfaces, even if these have superficial defects or a different surface appearance before surface processing by mechanical blasting due to the working or joining process.

Preferably the visible surfaces of the aluminum sheets of the container are uncoated, so that the costs of surface coating, for example for painting and drying, can be saved.

According to another embodiment of the container according to the invention the aluminum sheets of the container consist of an aluminum alloy of the type 3xxx, 5xxx and/or 6xxx. The aluminum alloys mentioned allow good mechanical blasting and show a clear increase in hardness of the surface after blasting. Depending on the application, for example whether particularly corrosion resistant materials and particularly good working properties are necessary or a compromise of both characteristics is required, the different aluminum alloy types can be selected as a function of the characteristics described above for producing a container according to the invention or individual sections of a container according to the invention.

Preferably the container according to the invention is a pressure vessel, a fuel tank, in particular a modularly-constructed fuel tank or a transport container for gaseous, liquid or free-flowing goods. The containers mentioned are usually produced from a number of aluminum sheets, so that their surfaces must be coated in order to obtain a uniform appearance of the surfaces. In the case of the containers according to the invention on the other hand a uniform surface structure is achieved by mechanical blasting of the different surfaces carried out after assembly, on account of which even superficial defects resulting from production are eliminated at least to a certain degree. The pressure vessels, fuel tanks and transport containers, preferably used uncoated, can be provided according to the invention in a simple and economic way but nevertheless meet high decorative requirements.

Since with the container according to the invention surface coating of the aluminum surfaces can be omitted, as already stated, the containers mentioned can be produced especially economically.

Particularly major economic advantages also result if the container is produced from a plurality of sections made of aluminum sheets. The individual sections then do not—according to the invention—need to be selected and joined corresponding to their surface properties, so that the rejection rate can be substantially reduced in the production of the containers.

There are many possible embodiments of the method according to the invention for producing containers as well as possible embodiments of the containers according to the invention. The description below describes one possible embodiment in conjunction with a drawing showing an exemplary embodiment of a container produced according to a method according to the invention, in this case a fuel tank for a heavy goods vehicle.

### DESCRIPTION OF THE DRAWINGS

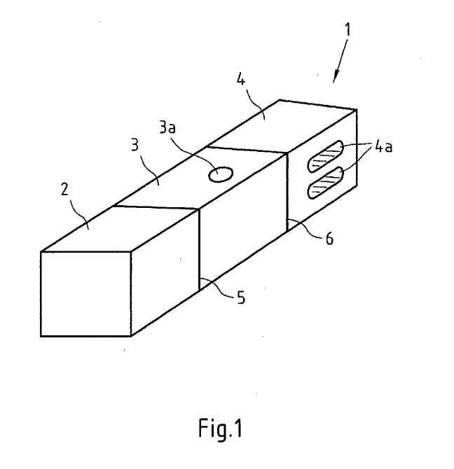

The fuel tank 1 of a heavy goods vehicle illustrated in FIG. 1 consists of three sections 2, 3, 4 which are joined together by weld seams 5, 6. Usually the three sections 2, 3, 4 are produced separately from one another using aluminum sheets originating from various production batches. In addition the different sections 2, 3, 4 can also however be made from different aluminum alloys, adapted to the respective function or also just have different thicknesses. In the present exemplary embodiment the different functions of the sections are indicated by a filler opening 3a and access steps 4a. Already a different appearance of the aluminum surfaces, which is in particular clearly visible to the human eye, results through the different process parameters associated therewith of the aluminum sheets used to produce the sections 2, 3, 4. In addition, however, varying storage times and influences of the weather can lead to a different appearance in the surfaces of the aluminum sheets used, particularly of the sections 2, 3, 4 of the fuel tank 1, so that the decorative impression of the container 1 is not optimum after assembly. According to the invention the surface of the entire fuel tank 1, only after this is at least partly assembled, is now subjected to processing by mechanical blasting. If necessary a different appearance of the aluminum surfaces is equalized by mechanical blasting and a uniform, metallically bright aluminum surface is produced. It is essential here that before mechanical blasting at least the aluminum sheets, which are later visible on the finished container, are joined together and/or formed since otherwise there is a danger that superficial defects, arising for example when the container is handled during assembly, are left on the surfaces and lead to rejection. The mechanical blasting according to the invention of the aluminum surfaces of the container namely result in the fact that for example scratches or defects arising on the surfaces when the metal sheets are produced can be eliminated to a certain degree. The rejection and rework rate therefore can be substantially reduced during assembly of the containers. Furthermore a particularly high degree of hardening of the surface is achieved without removing too much material from the aluminum surface if the particles, which are used for blasting, are directed substantially perpendicularly onto the aluminum surfaces to be blasted. In addition, however, it is conceivable if the particles are directed at another angle onto the aluminum surface.

1. Method for producing a fuel tank from sheets of aluminum or an aluminum alloy, wherein the surfaces of the aluminum sheets are at least partly visible on the finished fuel tank, and as a result of working and/or joining at least the aluminum sheets, which are visible on the finished fuel tank, the fuel tank is at least partly prefabricated and subsequently the entire, at least prefabricated fuel tank is subjected to surface processing by mechanical blasting.

2. Method according to claim 1, wherein the fuel tank is finally assembled by working and/or joining the aluminum sheets and the entire, finally assembled container is mechanically blasted in a last manufacturing step.

3. Method according to claim 1, wherein mechanical blasting is carried out using glass beads, corundum, white corundum, sand and/or steel balls.

4. (canceled)

5. Method according to claim 1, wherein aluminum sheets made from an aluminum alloy of type 3xxx, 5xxx and/or 6xxx are used.

6. Fuel tank at least partly consisting of sheets of aluminum or an aluminum alloy, wherein the surfaces of the aluminum sheets used are visible at least partly on the container and after at least partial assembly of the container by joining and/or working the aluminum sheets, the visible aluminum surfaces of the container are surfaces-processed by mechanical blasting of the entire, at least prefabricated fuel tank and the visible surfaces of the aluminum sheets of the fuel tank are uncoated.

7. (canceled)

8. Fuel tank according to claim 6, wherein the aluminum sheets of the fuel tank consist of an aluminum alloy of the type 3xxx, 5xxx and/or 6xxx.

9. Fuel tank according to claim 6, wherein the fuel tank is modularly-constructed.

10. Fuel tank according to claim 6, wherein the fuel tank is built up from a plurality of sections made of aluminum sheets.
